(19) United States
(12) Patent Application Publication
(10) Pub. No.: US 2009/0244510 A1
(43) Pub. Date: Oct. 1, 2009

(54) PROCESS AND APPARATUS FOR THE PRODUCTION OF COLLIMATED UV RAYS FOR PHOTOLITHOGRAPHIC TRANSFER

(75) Inventor: Piotr Domanowski, Solec Kujawski (PL)

Correspondence Address: MOETTELI & ASSOCIATES SARL, ST. LEONHARDSTRASSE 4, ST. GALLEN, CH-9000, CH

(73) Assignee: RADOVE GMBH, Berlin (DE)

(21) Appl. No.: 11/721,348

(22) PCT Filed: Dec. 13, 2005
(86) PCT No.: PCT/IB05/03818

§ 371 Date: Jun. 11, 2007

Related U.S. Application Data
(60) Provisional application No. 60/635,831, filed on Dec. 14, 2004.

(51) Int. Cl. G03B 27/54

(52) U.S. Cl. 355/70

(57) ABSTRACT

The present invention provides an improved process and an apparatus for producing collimated UV radiation for exposing printed circuit boards. The process consists in shortening the optical length of the downstream optics by dividing the UV radiation over many radiation sources, and in distributing the UV radiation uniformly on the substrate by using a scanning slide.

### FIELD OF THE INVENTION

The invention relates to a collimation optics for the photolithographic transfer of patterns onto substrates coated with a photosensitive polymer. More specifically, the present invention relates to collimated UV optics for photolithographic transfers onto printed circuit boards.

### BACKGROUND OF THE INVENTION

Exposure systems with UV collimation optics are used for exposing printed circuit boards with conductor tracks<100μ.

UV collimation optics are known in the field. See for example, the descriptions in EP 618 505, EP 807 505, EP 807 856, DE 41066 7311, and US 2002/016 7788 A1, the contents of which are incorporated herein by reference. The prior UV collimation optics collect the UV radiation of a mercury short arc lamp at the focus of an ellipsoidal mirror and expand this focus to a parabolic mirror via a collimation optics. The UV rays leave the parabolic mirror in a fashion that is collimated and perpendicular to the substrate.

In the scanning optics described in DE 42 066 73 A1 (the content of which is incorporated herein by reference) and US 2002/0167788A1, the expansion is performed in the form of strips over the short dimension of the substrate. US 2004/0166249, incorporated herein by reference, describes the use of LEDs for curing polymers with a number of spectral sensitivity maxima.

Focusing and expanding in known UV collimation optics require long optical paths. These optics therefore have a large space requirement and are very expensive. What is needed therefore is an apparatus and/or method of expanding and focusing that does not require long optical paths, and therefore are more practical and generally less costly.

### SUMMARY OF THE INVENTION

The present invention provides an improved process and an apparatus for producing collimated UV radiation for exposing a photosensitive substrate on printed circuit boards. The process and apparatus of the present invention does not require the long optical paths of prior collimated UV radiation devices in the field. The present invention accomplishes the object of shortened optical length of the downstream optics by dividing the collimated UV radiation from an up-stream radiation source into a plurality of secondary radiation sources, and by distributing the UV radiation from the secondary source to uniformly radiate the target substrate by using a scanning slide.

In preferred embodiments, the secondary (or “mini”) UV radiation sources were provided using one of two techniques. In a first technique, the mini UV radiation sources were provided by beam splitting the radiation of a 5-8 kW mercury point source lamp and distributing the split beams over the inputs to a plurality of UV liquid light guides. In a similar fashion, the collimated UV radiation output from a single waveguide was itself beam split to provide input to a plurality of UV liquid light guides. In a second technique, the mini UV radiation sources were provided by using the UV radiation of an array or matrix of UV emitting LEDs.

In a preferred embodiment of the second technique, the UV LEDs are bonded or soldered directly on a heat sink. In this embodiment, it is also preferred that the heat sink material is cooled to an appropriate temperature, e.g., 6° C. using water cooling, in order to maximize the service life and to help stabilize the UV output radiation of the UV LEDs.

In the preferred embodiment, the UV LEDs and UV LED chip clusters are arranged as a square, and the square arrangement is rotated by 45° so that the diagonal of the chip clusters is parallel to the direction of scanning movement of the scanning slide. Given suitable magnification of the square radiation source by the collimation lenses, these are projected on the substrate rhomboidal subareas whose radiation densities add up optimally during scanning with the radiation densities of the rhomboidal subareas of adjacent LEDs and further yield good uniformity. Details of this process are described in the exemplary embodiments viewed with the aid of the drawings.

The LEDs are combined in groups, preferably two rows of eight items, and supplied in series with a constant current. A step-up converter performs the control. A 5.1 V Zener diode (Z-diode) is connected in parallel with each LED. In the event of interruption by an LED defect, the Zener diode ensures the current continues to flow through the remaining LEDs in the series, and failure of the exposure machine is avoided.

The collimation optics comprises a multilens plate, produced by milling from UV-compatible acrylic glass. The aspheric lens shape is optimally calculated for the imaging. The collimation angle can be varied by motorized adjustment of the spacing of the multilens plate from the mini UV radiation sources. The angle is preferably adjustable from 2 to 10°.

The process of the programmable collimation angle uses this apparatus in order to set the optimum collimation angle automatically after stipulation of job parameters as a function of clean room quality, resolution of the conductor tracks and technology (liquid resist/dry resist).

The uniformity of the exposure is an important variable for the functioning of the resist in the subsequent process steps: development/electroplating/etching. It is therefore advantageous to introduce the exposure energy into the substrate uniformly.

The invention supplies further processes and apparatuses, which again improve the uniformity, in relation to the advantageous processes described for improving the uniformity.

US 2004/0166249 describes selection methods that cannot be used here, and are therefore replaced by what follows.

The present invention selects in accordance with UV power/mA, and uses the selected groups for different exposure systems. The invention additionally selects according to UV spectra of the LEDs and uses them for different resist types/and/or soldering resist.

A calibration apparatus measures and collects performance data for use in the design of a lateral aperture inserted in the UV ray path in order to improve uniformity, and a process for producing the aperture. The calibration apparatus is located in an edge region of the exposure machine and has a photocell that can be displaced transverse to the scanning direction of the scanning slide with the aid of a toothed belt drive. The photo-element is adjusted in stepwise fashion.

The radiant power of the UV collimation optics is thereby measured in the form of strips. The result is used by the computer to produce an aperture contour that is put laterally into the ray path and largely compensates the deviation in the UV radiant power. The photoelectric cells are also used, in order that the intensity waste of the UV-LED's, due to heating up of the chip after switching on of the lighting, to compensate over the change of the scanning speed of the increase of the lamp stream to compensate.

The invention supplies a process that produces from the measured data a program for the printed circuit board milling machine used to produce a milled part that can be used as aperture contour for improving the uniformity. The user is thus in the position of measuring his machine periodically (e.g., yearly) and himself producing the required calibrated aperture with a low outlay.

A further method improves the uniformity errors that are produced by an unsatisfactory stability of the scanning movement. US 2002/016 788 A1 describes a method of controlling the exposure energy/cm² for the resist merely by varying the scanning speed. The resist/soldering sensitivities range from 10 mJ/cm² to 500 mJ/cm². Because of the wide span, it is not possible to adapt the exposure energy to the resist merely via the variation of the scanning speed. The present invention therefore uses constant speeds for which optimal PID parameters are respectively fixed for the purpose of motor control. The fine control and the further adaptation of the range are performed solely via control of the current to the LEDs. Only thus is it possible to have a resolution of 1% in the case of the energy density for all the resist/soldering resist exposures.

There is a need for inexpensive, compact UV collimation optics. The object is to supply a UV collimation optics that is substantially improved in relation to the prior art and whose optical path length is shortened from 1000 mm to 40-80 mm. The optical path length of a UV collimation optics is substantially determined by the size of the substrate surface onto which the focused UV radiation is expanded. Consequently, according to the invention, the shortening of the optical path length is achieved by replacing the 5-8 kW mercury short arc lamps by mini UV radiation sources. These expose only a subarea of the substrate. The downstream collimation optics has correspondingly short optical path lengths.

The present invention uses two versions as mini UV radiation sources: the radiation outputs of multiarm UV liquid light guides, and the radiation of UV LEDs.

In order to achieve a uniform exposure, the mini UV radiation sources are moved over the substrate at a suitable speed on a scanning slide.

Further advantages are:
collimation angle that can be adapted to clean room quality and process
an improvement in the uniformity of the exposure from +/−10 to +/−5%
minimal development of heat in machine and clean room
energy saving per exposure system of 100 kW/h per year in the UV LED version
service lives of the lamps improved from 1,000 hours to 100,000 hours (in the UV LED version).

### BRIEF DESCRIPTION OF THE DRAWINGS

FIGS. 1, 2 show mini UV radiation sources based on liquid light guides.

FIGS. 3, 4 show mini UV radiation sources based on UV LEDs.

FIG. 5 shows UV collimation optics in an exposure frame.

FIGS. 6A-6C shows a detailed description of a UV collimation optics with a wedge slide as Z-actuator of the lens plate.

FIGS. 7A-7D shows a UV LED module in detail.

FIG. 8 shows a calibration apparatus for measuring the parameters for an aperture contour.

FIG. 9 shows a schematic of the calibration process.

FIG. 10 shows a perspective view of the projection of UV LEDs emissions onto the substrate.

### DETAILED DESCRIPTION OF THE PREFERRED EMBODIMENT(S)

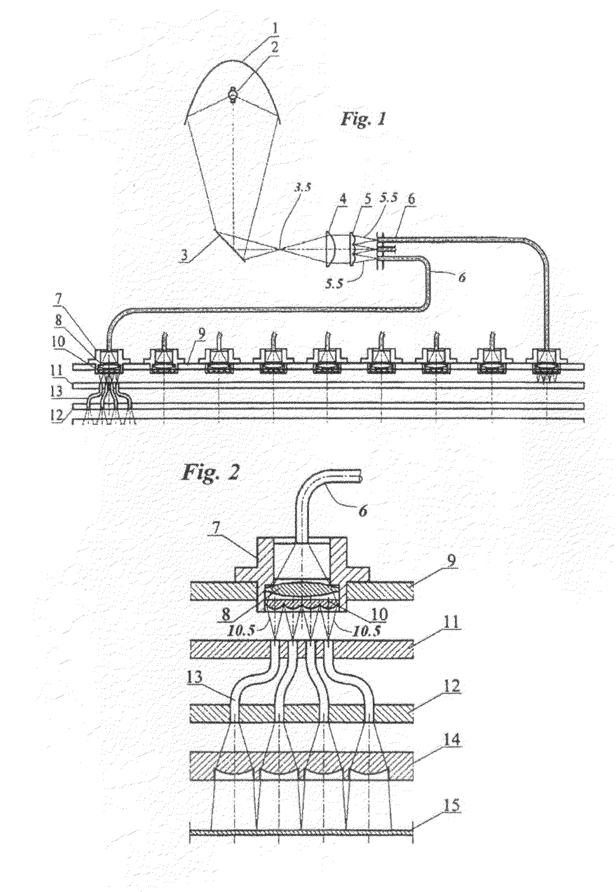

FIGS. 1, 2 show the UV collimation optics based on liquid light guides. In this embodiment, the UV radiation of a mercury short arc lamp (2) is concentrated at a focal point (3.5) with the aid of an ellipsoid (1). A cold light mirror (3) is disposed in front of the focal point (3.5) and deflects the beam (by 90° in the embodiment illustrated) toward a collimation lens (4). The collimation lens (4) concentrates the UV radiation onto a raster lens plate (5) that splits the beam into a plurality of split beams (5.5) and focuses the split beams (5.5) onto the entrance ports (6.5) of a multiliquid light guide (6).

The liquid light guides (6) transmit the UV radiation at low loss toward the base plate (9) of a scanning slide (50). Each liquid light guide (6) ends in a flange (7) that is fastened on the base plate (9). The component UV radiation beam of a liquid light guide (6) is concentrated with the aid of a 2nd collimation lens (8) onto a second raster lens plate (10). The UV radiation beam from the liquid light guide (6) is split by the second raster lens plate (10) into a plurality of second split beams (10.5). The secondary split beams (10.5) are each focused onto the entrance port (13.5) of a distributor light guide (13) at an intermediate plate (11), and transmitted toward the mini UV radiation source plate (12) on which the distal ends (12.5) of the distributor light guides (13) are mounted. The mini UV radiation sources emit from the distal ends (12.5) of the distributor light guides (13). The multilens plate 14 images the UV radiation from the distal end exit openings (12.5) of the distributor light guides (13) onto the substrate (15) with a magnification of 1:15.

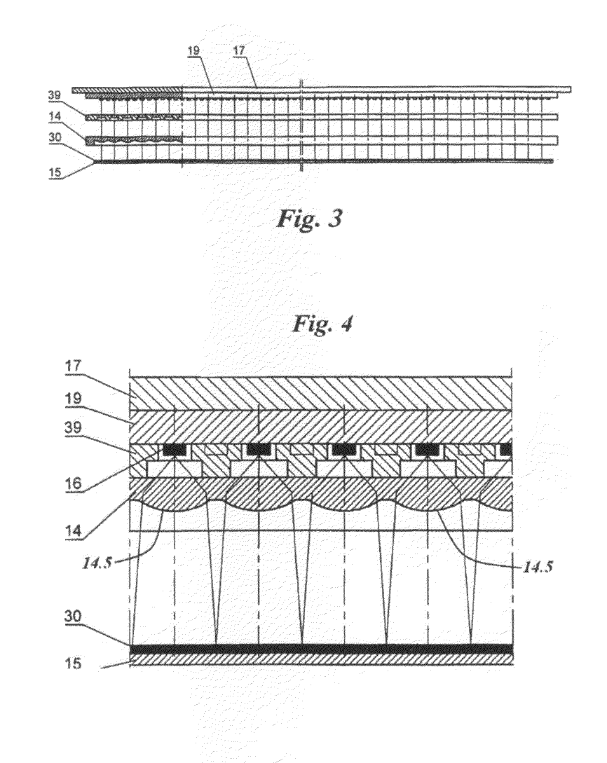

FIGS. 3 and 4 show the mini UV radiation source based on UV LEDs. The UV LED modules (19) are attached (by screws in the embodiment shown) to the base plate (17), which also serves as a heat sink with water cooling. The emission angle of the UV radiation is limited by a collimation aperture (39) to +/−45°. The radiation beam of each UV LED is imaged through the film (30) onto the substrate (15) with a collimation angle of between 1.5° and 10° by means of an aspheric lens (14.5) that is incorporated into a multilens plate (14).

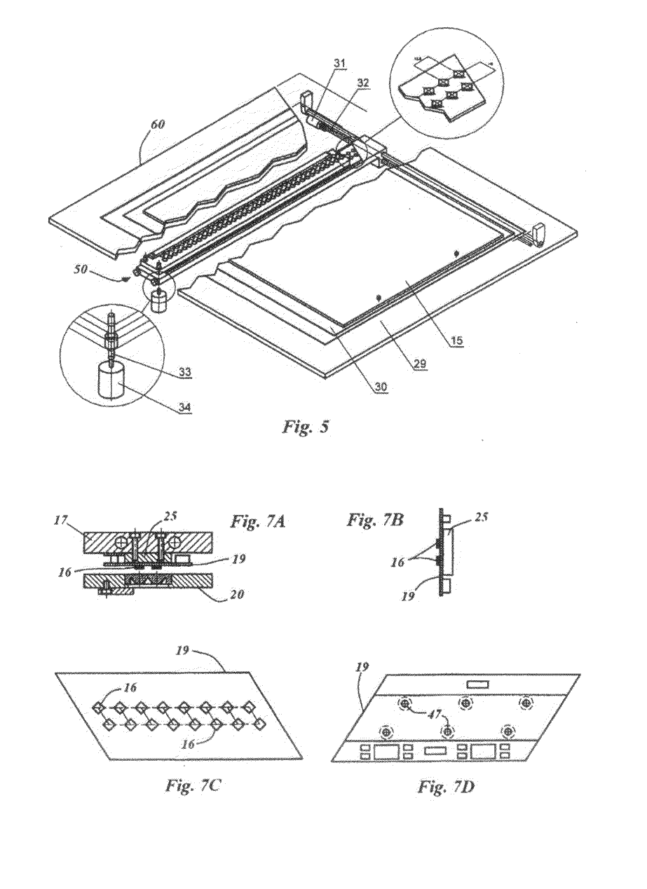

FIG. 5 shows a UV collimation optics in an exposure frame (60). Initially, the scanning slide (50) is in a parking position at the end of the frame (60). The film (30) and substrate (15) lie outside the radiation of the UV LEDs (16). The LEDs (16) are now switched on via the program. The scanning slide motor (31) moves the scanning slide (50) with the active LEDs over the substrate (15). In a preferred embodiment, three speeds can be provided for the scanning speed. The ball screw assembly (32) enables uniform feeding. The LEDs are switched off after the substrate (15) has been completely crossed over, and the scanning slide (50) moves into parking position. The collimation angle is set in this case via four Z-screws (33) driven by the toothed belt of a Z-motor (34).

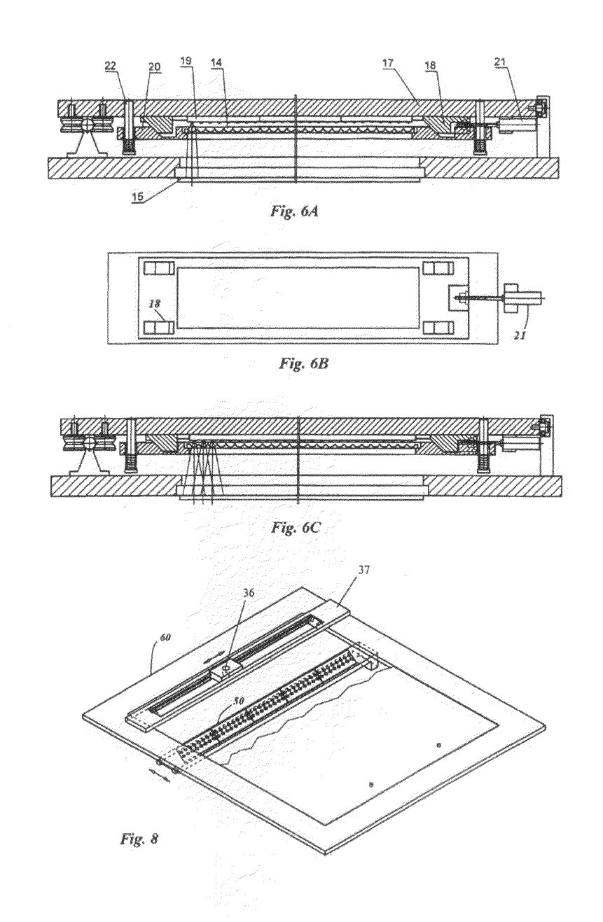

In a preferred embodiment shown in FIGS. 6A-6C, the UV collimation optics includes a base plate (17) with water cooling. UV LED modules (19) are mounted on the base plate (17) in two rows of eight LEDs (16) each, above a 12.5 mm raster lens (14). Below the LED modules (19) in figures is a lens frame (20) made from aluminum. The multilens plate (14) made from acrylic glass is disposed in a milled-out portion of the lens frame (20).

A plurality of aspheric lens (14.5) are incorporated into the acrylic glass of the multilens plate (14). Each aspheric lens (14.5) is disposed in a central fashion relative to an LED (16). The aspheric lens (14.5) have a shape calculated optimally for the imaging of the LED. The scale ratio is approximately 1:15.

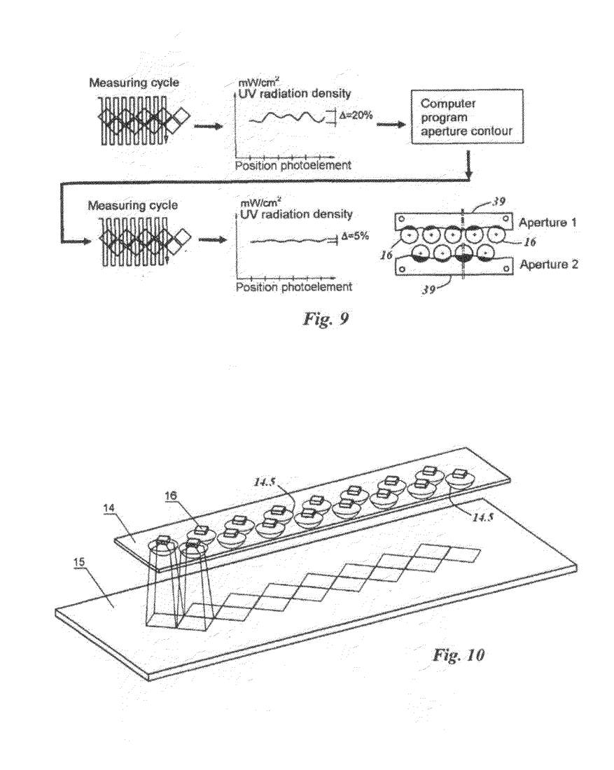

Fastened on the lens frame (20) is one or more aperture strips (not shown, see (39) in FIGS. 4 and 9) of which one side has a contour that has been calculated from the values of a calibration method described later. The aperture strip (39) is positioned partly in the ray path of the UV LEDs (16) and masks out a portion of the UV radiation such that the remaining radiation has a uniformity of +/−5%. The spacing of the aluminum frame (20) with the embedded multilens plate (14) from the LEDs is varied by a wedge slide (18). The changing of the spacing varies the exit angle of the UV radiation after passage through the lenses between 1.5 and 10°. The change is performed using programmed control via the motor (21). The scanning slide (50) can be moved relative to the exposure frame (60) via a ball screw drive assembly (32) and motor (31) (see FIG. 5). The scanning slide (50) is guided on one side by a corrugated guide (56) and supported on the other side by a castor assembly (58).

FIGS. 7A-7D show a preferred embodiment of the present invention. This embodiment includes an UV LED module (19) with components on two sides (see FIG. 7B). One side (FIG. 7C) is fitted with the LEDs (16). The other side (see FIG. 7D) has a cooling plate (25) fastened in the middle with the aid of a heat-conducting adhesive. In the embodiment shown, six threaded receptacles (47) in the plate (25) serve for fastening to the base plate (17) by means of threaded fasteners (not shown). As shown in FIG. 7A, the raster lens frame (20) is positioned about 0.1 mm from the LEDs (16) of the UV LED module (19).

Each LED (16) is electrically protected by a Z-diode in parallel. Upon interruption/failure of the LED, the current flow for the remaining 7 LEDs of the group is guided through the Z-diode. An electrical connection (not shown) lies on the other side (see FIG. 7D) of the on a strip lying outside the cooling plate (25). The two constant current controls for the group comprising the two by eight LEDs are constructed on the opposite strip. Modules and the positioning of the LEDs are calculated such that the modules can be lined up as desired.

FIG. 8 shows a preferred embodiment of a calibration apparatus (37) with a photo-element (36). The photo-element (36) moveable along the length of the calibration apparatus (37) as illustrated by a displacement motor (not shown). In the embodiment illustrated, the scanning slide (50) is moved back and forth so that the entire width of the radiation pattern of the UV LEDs (16) moves under the photo-element (36). The photo-element (36) is subsequently displaced along the length of the calibration apparatus (37). The average radiation density of the UV strip is measured in the form of strips with a raster of 2 mm. The values are measured by a computer program that describes the contour of a strip aperture. This strip aperture is milled and fastened in the ray path of the UV LEDs with the aid of locating pins. See FIG. 9. Other calibration methods utilizing the illustrated calibration apparatus (37) are known to and practicable in the present invention by the ordinary skilled artisan in view of the present description and figures.

FIG. 10 shows a schematic perspective of the present invention in which the UV emission beam of every mini-UV-radiation source LED (16) is collimated with a lens (14.5) on the raster plate (14) before the beam irradiates the substrate (15).

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A process for producing collimated UV radiation for photolithographic transfer of patterns onto substrates coated with photosensitive polymers, which includes the steps of:
(a) providing a number of mini UV radiation sources whose UV radiation is collimated with the aid of correspondingly short collimation optics,
(b) attaching the mini UV radiation sources to a support plate, and
(c) mounting the support plate onto a scanning slide, and exposing the substrate by moving the scanning slide parallel to one of the substrate sides.

2. The process as claimed in claim 1, in which each mini UV radiation source is collimated with the aid of a lens.

3. The process as claimed in claim 2, in which all the lenses are fitted on a multilens plate.

4. The process as claimed in claim 3, in which multilens plates have fixed collimation angles between 1° and 10° are used as a function of the clean room quality.

5. The process as claimed in claim 2, in which the in which multilens plates have an adjustable collimation angle variabled between 1° and 10° by a motorized adjustor communicating with the multilens plates.

6. The process as claimed in claim 5, in which adjustment of the collimation angle is performed under program control in accordance with prescribed job parameters.

7. The process as claimed in claim 1, wherein the mini UV radiation sources are outputs of multiarm UV liquid light guides.

8. The process as claimed in claim 1, comprising an apparatus wherein the mini UV radiation sources are outputs of UV LEDs.

9. An apparatus as claimed in claim 7, comprising:
(a) a mercury short arc lamp for producing UV radiation, an ellipsoid that concentrates the UV radiation at a focal point;
(b) a dielectric UV mirror that deflects the UV radiation onto a lens raster plate disposed beyond the focal point;
(c) the lens raster plate dividing the UV radiation and focusing the component split beams onto the inputs of a multiarm UV liquid light guide;
(d) the multiarm UV liquid light guide transmitting the UV radiation at low loss onto a scanning slide; and
(e) a distribution optics that distributes the UV beam emitted from the multiarm UV liquid light guide over a mini UV radiation sources support plate.

10. The apparatus as claimed in claim 9, in which the mercury short arc lamp, a lamp power supply unit and the dielectric UV mirror are mounted in an independent housing.

11. The apparatus as claimed in claim 10, wherein the independent housing is located in an environment separate from a mini UV radiation sources support plate environment.

12. The apparatus as claimed in claim 11, wherein the mini UV radiation sources support plate environment is a clean room and the independent housing is located outside the clean room.

13. The apparatus as claimed in claim 8, wherein the UV diodes are arranged in at least one row with a length that is greater than the smaller side of the substrate.

14. The apparatus as claimed in claim 13, in which the UV LEDs are arranged in clusters consisting of 1, 4, 8, 12, or 16 LEDs to form a square having a side that is rotated by 45° relative to the length of the row and to a scanning direction.

15. The apparatus as claimed in claim 14, wherein a diagonal of each square is magnified by the collimation lens to twice the spacing of the UV LED clusters such that the UV radiation energy of each cluster is added to the radiant energy of its adjacent clusters to form a uniform value on the substrate.

16. The apparatus of claim 14, wherein the UV LED cluster rows are arranged in at least two rows, with the diagonal of each cluster magnified by the collimation lens to a value that is calculated using the formula: 2×spacing of the clusters/number of rows, and each row is displaced from an adjacent row by a value that is calculated using the formula: spacing of the clusters/number of rows.

17. The apparatus as claimed in claim 8, wherein the support plate further comprises a heat sink plate.

18. The apparatus as claimed in claim 17, wherein the heat sink plate includes a heat sink that is cooled using a water cooling means.

19. An apparatus as claimed in claim 18, wherein the cooling is uncontrolled until the heat-sink plate reaches a minimum temperature, preferably of 6° C.

20. The apparatus as claimed in claim 8, wherein the UV LEDs are controllable and can be turned on and off in a programmed fashion to expose only an intended region of the substrate when the scanning slide travels over the substrate.

21. The apparatus as claimed in claim 8, wherein an intensity of UV exposure on the substrate is controllable by controlling scanning speed and current to the UV LEDs.

22. A process for controlling an intensity of UV exposure in an apparatus as claimed in claim 21, which includes the steps of:
(a) providing a control program by which a number of constant speeds are determined with the aid of hardware using PID parameters optimal for these speeds, the determined speeds being reduced by a fixed reduction factor, preferably 0.8 to provide a related set speed, and which set speeds are selectively capable of being switched in;
(b) selecting a set speed for a resist/solder mask substrate such that the optimum UV exposure energy is produced when the resist/solder mask substrate is exposed at this speed; and
(c) controlling any overexposure thereby induced by adjusting current to the UV LEDs to an appropriate value.

23. The process as claimed in claim 22, in which, in the case of highly sensitive resists, the speed is limited to a value that is prescribed by the stability of the mechanism, and the adaptation of the UV exposure energy is performed via an additional reduction factor FV of the UV LED current control, which is calculated using the formula: FV=maximum mechanically possible scanning slide speed/calculated scanning slide speed for a correct UV exposure energy.
The UV radiation is then reduced by current control using the total factor 0.8×FV.

24. The apparatus as claimed in claim 18, including a calibration mechanism, the calibration mechanism comprising: a UV photo-element as measuring sensor mounted on a calibration slide that can be displaced transverse to the scanning slide by a motor, the calibration slide being mounted in a region of the exposure frame that lies outside the exposure area, while the full width of the scanning slide can be traveled over by UV photo-element of the calibration slide.

25. The process and apparatus as claimed in claim 24, wherein the UV radiation of the mini UV radiation sources is measurable in the form of strips by stepwise adjustment of the calibration slide and respectively subsequently traveling over the UV photo-element with the scanning slide to provide a measured UV radiation profile.

26. The apparatus as claimed in claim 25, wherein the measured UV radiation profile is used to produce an aperture that, when placed laterally into the UV ray path, improves the uniformity of the exposure by masking out.

27. The process as claimed in claim 25, wherein the measured UV radiation profile is processed by a computer program to generate a milling program that can be executed on a printed circuit board milling machine used at the customer plant to produce milled parts for used as apertures to improve the uniformity of the UV exposure energy.

28. The process as claimed in claim 27, wherein the apertures are made a plate material, and preferably double clad FR 4/1.5 mm.

29. The process as claimed in claim 25, wherein, with the scanning slide in a park position, the UV radiation is measured with the photo-element by rise in temperature of the LEDs after being switching on, to provide a measured UV radiation profile including measurements useful to determine set speeds and LED currents compensated for heat induce, exposure intensity changes.
